(19) United States
(12) Patent Application Publication
(10) Pub. No.: US 2021/0381923 A1
(43) Pub. Date: Dec. 9, 2021

(54) SENSOR FOR DETECTING MECHANICAL CHANGES AT AN EARLY STAGE

(71) Applicant: MACK RIDES GMBH & CO. KG, Waldkirch (DE)

(72) Inventor: Andreas FRIEDBERGER, Waldkirch (DE)

(21) Appl. No.: 17/055,832

(22) PCT Filed: Mar. 26, 2019
(86) PCT No.: PCT/EP2019/057630

§ 371 Date: Nov. 16, 2020

(30) Foreign Application Priority Data
May 18, 2018 (DE) 10 2018 111 998.4

(51) Int. Cl. G01M 5/00

(52) U.S. Cl. CPC G01M 5/0033; G01M 5/0083

(57) ABSTRACT

The present invention relates to a sensor system (1) for detecting mechanical changes, in particular material fatigue and wear and tear, at an early stage, comprising a sensor housing (2) having a receiving region (21) and a sensor head (4), wherein the sensor head (4) is maintained on the receiving region on the sensor housing (2) and is at a distance, at least in regions from the sensor housing (2). The sensor head (4) comprises a breaking body (40) having at least one measuring conductor (50). The at least one measuring conductor (50) is electrically connected by means of at least one electronic measurement unit (25) in the sensor housing (2), and the electrical resistance of the at least one measuring conductor (50) can be detected by the electronic measurement unit (25).

The present invention relates to a sensor system for the early detection of mechanical changes and thus serves to increase the safety of a fairground ride, for example, with the features of claim 1, a sensor head for a sensor system according to claim 20 and a fairground ride with such a sensor system with the features according to claim 26.

Sensor systems for increasing safety are known in different configurations from prior art. Such sensor systems known from prior art detect mechanical changes that occur, for example, as a result of wear or fatigue of the material. The sensors used for this purpose detect at least one mechanical load or mechanical change in the fairground ride and compare the detected values with reference values that are stored in a database. If, for example, changes in the mechanical load occur due to wear or fatigue, these changes are detected early by the sensor system. Alternatively, such sensor systems can be formed from a first component and a redundant component, the sensor system detecting the failure of a first component by opening or closing an electrical contact when a load is taken over by the redundant component. Such a sensor system is for example already known from DE 10 2014 114 338 A1.

A disadvantage of this prior art has been that the known sensor systems to increase the safety of a fairground ride require a voltage supply through which the sensors are supplied with an electrical voltage and are connected via cables, for example, to a monitoring circuit of the fairground ride in order to detect fault conditions. Particularly in fairground rides, for example a roller coaster or a water ride with moving vehicles, cabins, floating bodies or the like, the sensor systems known from prior art often require a voltage source to be carried in order to ensure proper functioning of the sensor system and in order for the detected signals to be transferred to a monitoring circuit of the fairground ride. Such sensor systems for increasing the safety of a fairground ride have proven to be complex and costly and, moreover, increase the weight of the vehicle, the cabin or the floating body, which results in further disadvantages.

It is therefore the object of the present invention to provide a sensor system for the early detection of mechanical changes, in particular material fatigue and wear and thus to increase the safety of, for example, a fairground ride, which eliminates the disadvantages of the sensor systems known from the prior art. In particular, the sensor system for increasing safety should be able to be operated without being connected to a voltage source and be able to detect material-independent mechanical changes, in particular in a passenger fairground ride.

A large part of the components of a fairground ride, for example, are usually made of a metallic material, but there are also components and even entire fairground rides that are made substantially of non-metallic materials, for example plastic or wood. The sensor system according to the invention should be able to be used without restriction for detecting mechanical changes for all materials.

The sensor system should also enable redundant detection of mechanical changes, in particular material fatigue and wear, which can be detected by different measurement methods, whereby detected mechanical changes in the fairground ride can be verified independently of one another, whereby incorrect detections are reduced and as a whole a contribution is made towards increasing the safety of the fairground ride.

The stated objects are solved by means of a sensor system according to claim 1, a sensor head according to claim 20 and a fairground ride with the features of claim 26. The dependent claims contain advantageous further developments of the invention.

The sensor system according to the invention for the early detection of mechanical changes comprises a sensor housing with a receiving region and a sensor head, the sensor head being held in the receiving region on the sensor housing and projecting beyond the sensor housing at least in some areas. The sensor housing can be designed as a rotationally symmetrical stainless steel tube with an external thread, the external thread further preferably being a metric thread and the receiving region in the sensor housing being designed in the manner of a coaxially formed blind hole. In addition, the sensor head comprises at least one breaking body with a measuring conductor. The breaking body is preferably an elastic or brittle solid body. The at least one measuring conductor is electrically connected to an electronic measurement unit arranged in the sensor housing, the electronic measurement unit arranged in the sensor housing detecting the electrical resistance of the measuring conductor of the sensor head. The size of the sensor head and the receiving region of the sensor housing are coordinated in such a way that the breaking body of the sensor head protrudes from the receiving region at least in some areas and is exposed in this area to unprotected mechanical changes that occur in the component to be monitored. In the event of a mechanical change in the component to be monitored, the breaking body is destroyed or deformed and the electrical resistance of the measuring conductor changes or the electrical conductivity of the measuring conductor is destroyed, whereby the mechanical change in the component to be monitored can be detected by an electrical signal. For this purpose, the electronic measurement unit is preferably connected to the measuring conductor at both ends. The electronic measurement unit enables the detection of a change in the electrical resistance through an electrical connection to the two ends of the measuring conductor. For this, the measuring conductor is coupled to the measuring body.

In addition, it is possible that the at least one measuring conductor is connected to an RFID transmitter-receiver system, or to a conventional feedback or emergency stop circuit.

Another advantageous embodiment of the present invention provides that the breaking body of the sensor head is made of an electrically insulating material, and that the at least one measuring conductor extends as a contact loop in or on the breaking body. The at least one measuring conductor can preferably be placed, molded or incorporated onto the breaking body, the breaking body protecting the measuring conductor from mechanical influences and preventing a short circuit between the measuring conductor and adjacent components.

In addition, the at least one measuring conductor can be arranged on the surface of the wall facing away from the medium, with a protective layer furthermore preferably being applied to the wall, which protects the measuring conductor or the contact loop, shields it in an electrically insulating manner and also fixes it on the wall.

Furthermore, the at least one measuring conductor can be placed in the form of an electrical material on the breaking body or in its wall.

It is preferred if at least one electrical connection between the at least one measuring conductor of the sensor head and the electronic measurement unit in the sensor housing is a detachable plug connection. The sensor head can thus be exchanged in a particularly simple manner, with the at least one electrical connection being established at the same time. The at least one electrical connection is preferably arranged in the receiving region in the sensor housing. The interchangeability of the sensor head also means that a kind of modular system is implemented. The sensor housing can be a standard component and the sensor head can be a component adapted for the intended use, it being possible for the sensor heads to be variable both in terms of their dimensions, i.e. the extent to which the sensor heads project beyond the sensor housing from the receiving region, and in terms of the resistance of the breaking body and of the selected medium. The more resistant the breaking body is, the more pronounced the mechanical changes to be detected on the component to be monitored must be.

The sensor head is furthermore preferably held positively and/or non-positively in the receiving region on the sensor housing by the electrical contact, so that no further fastening means are necessary besides the electrical contacts for locking the sensor head in the receiving region.

Another advantageous embodiment of the present invention provides that a guide is provided in the receiving region between the sensor housing and the sensor head, by means of which the sensor head is kept vibration-mechanically decoupled from the sensor housing or is held in a damped manner The guide is preferably made from an elastomer or a rubber-elastic polymer, the guide more preferably exerting a clamping force on the sensor head. The clamping force of the guide holds the sensor head in the receiving opening. A damping material with a hardness of 70 Shore is particularly preferred. In addition, the guide prevents failure of the breaking body due to mechanical interaction between the sensor head and the sensor housing, for example due to vibrations on the component of the fairground ride to be monitored.

It is also advantageous if the breaking body is made from a brittle material. In particular, it has also proven to be advantageous if the breaking body is made from a ceramic material, from glass or glass ceramics. In particular, glass is preferred as the material, since glass has excellent mechanical, electrical and chemical properties and a sensor head with such a breaking body can also be manufactured inexpensively in different sizes. The material or the material combination from which the breaking body is made can, however, be selected as desired. Plastics can for example also be used.

The breaking body can preferably be made of an elastic material, for example plastic, or particularly elastic materials such as rubber, hard rubber or the like can be used.

Furthermore, it has proven to be advantageous if the breaking body is designed as an ampoule and has a wall that encloses a medium. The wall can form a container in the breaking body. The medium can be used as an indicator, for example for optical and/or visual and/or acoustic and/or olfactory measuring methods. This enables an optical and/or visual and/or acoustic and/or olfactory early detection of the mechanical change in the component to be monitored. In connection with the present invention, a tight container is understood to mean a container which is configured in such a way that in the initial state, that is, intact or undeformed, it stores the enclosed medium tightly, that is, also without diffusion. Furthermore, in the context of this invention, a medium can furthermore be understood to mean any type of medium in the solid, liquid or gaseous state of aggregation which can be flowable and/or pourable. A medium is pourable in its solid aggregate state if it comprises a granular or lumpy mixture.

According to an advantageous embodiment of the present invention, the at least one measuring conductor is arranged in or on the wall of the breaking body or the ampoule. The wall protects the measuring conductor from mechanical influences and can prevent a short circuit between the measuring conductor and adjacent components.

Furthermore, it has proven to be advantageous if the medium in the breaking body or in the ampoule is electrically conductive and the at least one measuring conductor is formed from at least one first electrode and at least one second electrode. The first electrode and the second electrode are arranged at a distance from one another in the breaking body and protrude into the medium. Accordingly, the electrical resistance between the at least one first electrode and the at least one second electrode can be detected by the electronic measurement unit in the sensor housing. If the breaking body is destroyed due to mechanical changes in the component to be monitored, the medium flows out of the breaking body and the electrical resistance between the at least one first electrode and the at least one second electrode changes, whereby the mechanical change on the component can be detected electrically.

According to a further advantageous embodiment of the present invention, the medium in the breaking body or in the ampoule is a liquid and/or a gas. More preferably, the medium in the ampoule formed by the breaking body is provided with an optically and/or visually and/or olfactorily perceptible marker which, if the breaking body is destroyed, runs out, spills out or flows out together with the medium and marks the at least one component to be monitored. The marking by means of the marker can be read out or monitored visually, for example using a camera, or visually by an operator of the fairground ride. From an olfactory point of view, the marker can release odors that can be perceived by the senses of an operator or serve as an attractant for animals, for example insects, which in turn serve as markers. The liquids of adjacent sensor systems can be provided with different optically and/or visually and/or olfactorily detectable markers, so that a differentiation can be made between the adjacent sensor systems. The medium can also contain chemical additives which are configured to trigger a chemical reaction, as a result of which improved sensory perception can be achieved. Such a chemical additive can be, for example, an ionic liquid. The medium can furthermore comprise a non-Newtonian fluid or thermal fluid. The medium can also be a smoke gas, smoking powder or oxyhydrogen gas, or odor-intensive additives such as fragrances, e.g. essential oils, that are perceived as pleasant or unpleasant, can be used. For example, hydrogen sulfides, which are colloquially known as “stink bombs”, or defense substances, which are known as “pepper sprays”, can be used.

In addition, according to the present invention, the medium can be completely or partially pourable and can comprise a granular or lumpy mixture. The medium can comprise, for example, glass, ceramic, plastic, metal grains and/or beads and/or small plates. The completely or partially pourable medium can trigger a reaction.

According to a further embodiment of the present invention, the medium in the sensor head can be configured to act on the at least one measuring conductor when there is a certain pressure or a force on the sensor head and to generate an electrical signal by disconnecting or opening an electrical connection. In particular, it can be preferred if the breaking body is made of an elastic material and if an electrically conductive medium, in particular a pourable medium, triggers contact with the measuring conductor when the sensor head is deformed. In particular, it can be advantageous if the pourable medium comprises small metal plates.

Furthermore, it has proven to be advantageous if the medium in the sensor head is pressurized. The application of pressure to the medium ensures that even the finest hairline cracks in the sensor head cause the medium to escape from the sensor head and leave behind an optically and/or visually perceptible mark. The medium in the sensor head can for example have an overpressure of a few pascals up to several times atmospheric pressure.

Another preferred embodiment of the sensor system according to the invention provides that the sensor system has a radio unit by means of which the electrical resistance of the at least one measuring conductor or the electrical conductivity of the at least one measuring conductor can be queried. The radio unit can be arranged as a separate electrical component in the sensor housing, or it can be integrated into the electronic measurement unit. The radio unit is set up to communicate with a reader of the fairground ride.

Furthermore, it is particularly preferred if the radio unit is an RFID chip that can be controlled and read out via a UHF frequency. Each radio unit has a unique identifier which is passed on to the reader when it is queried, so that a possible detection of a mechanical change in the at least one component to be monitored can be precisely assigned to it. The RFID chip is stimulated by the frequency of the reader and generates its own current or voltage that lasts for a short time and that is passed through the measuring conductor of the sensor head. The passage of this current or voltage enables the electrical resistance or the electrical conductivity of the measuring conductor to be checked without the need for an energy source to be carried. The reader receives the signal, the reader also preferably being integrated into a monitoring circuit of the fairground ride. If an error is detected, an error signal can be generated and, for example, an emergency stop of the fairground ride can be carried out.

A further advantageous embodiment of the invention provides that the sensor head and/or the sensor housing have or has substantially a cylindrical shape, and that the sensor head is radially surrounded in some areas by the sensor housing in the receiving region. In particular, the radial shape of the sensor head or the breaking body enables a particularly simple manufacture.

Furthermore, it is advantageous if the sensor housing has at least one fastening means which is set up to fasten the sensor housing to the at least one component to be monitored. The fastening means can establish a positive and/or non-positive connection with the at least one component to be monitored, with material connections in the sense of this invention also being able to be used to fasten the sensor housing to the at least one component to be monitored.

The fastening means is particularly preferably designed as a standardized external thread, for example as a metric ISO fine thread in accordance with DIN 13, which means that the sensor system can be installed and positioned without significant effort.

The sensor housing can also have a sensor cable connection which is set up to be connected to a monitoring circuit of a fairground ride. The monitoring circuit can be, for example, a feedback circuit, an emergency stop circuit or the like, with the measuring conductor preferably being able to be operated as an NC contact. It is also conceivable that a cable break is detected and read out. In particular, a combination of a wired connection to the monitoring circuit, together with wireless monitoring by means of the radio unit and possible optical and/or visual detection of the medium, can create multiple redundancy, which reduces incorrect detection of mechanical changes in the at least one component to be monitored.

The present invention also relates to a sensor head, the sensor head comprising a breaking body with a measuring conductor. The breaking body is preferably a solid body produced as a solid or hollow body, either from an easily breakable material, preferably glass or ceramics, or from an easily deformable material, for example rubber, and further preferably has a cylindrical shape along a longitudinal axis, with a breaking body foot at one end and a breaking body head at the other end. The breaking body foot is configured to be coupled to the sensor housing and the breaking body head is configured to protrude at least in some areas in the direction of the at least one component to be monitored.

In addition, it is particularly advantageous if the measuring conductor of the sensor head is designed as a contact loop, the contact loop being formed from a U-shaped electrical conductor that extends substantially from the breaking body foot to the breaking body head and back into or on the breaking body or a wall of the breaking body. The two free ends of the electrical conductor are each connected to a contact point which is designed to be electrically connected to the electronic measurement unit in the sensor housing by means of an electrical connection.

According to the present invention, it is advantageous if the breaking body has a wall that encloses a medium. The medium can be used as an indicator for optical and/or visual and/or acoustic and/or olfactory measuring methods—as already described in detail above. The wall of the breaking body forms a container that encloses the medium.

Furthermore, it is particularly advantageous if the medium enclosed in the breaking body or the ampoule is electrically conductive and the at least one measuring conductor is formed from at least one first electrode and at least one second electrode. The first electrode and the second electrode are spaced apart from one another in the breaking body and protrude into the medium. Accordingly, the electrical resistance between the at least one first electrode and the at least one second electrode can be detected by the electronic measurement unit in the sensor housing. If the breaking body is destroyed, the medium escapes from the breaking body and the electrical connection between the at least one first electrode and the at least one second electrode is interrupted.

It is also particularly advantageous if the medium in the sensor head is provided with a marker. The marker is particularly preferably a visually and/or optically detectable means. The marker is more preferably designed in such a way that the medium is fluorescent.

It has also proven to be advantageous if the medium in the sensor head or in the breaking body is pressurized.

Another embodiment of the sensor head provides that the electronic measurement unit and/or the radio unit are or is arranged on or in the sensor head. Furthermore, the electronic measurement unit can be arranged on or in the wall of the breaking body or the ampoule.

Another aspect of the present invention relates to a fairground ride with at least one sensor system according to the invention. The sensor system according to the invention can either be attached to the at least one component of the fairground ride to be monitored during the manufacture of the fairground ride or retrofitted to existing fairground rides without any significant cabling effort.

Another advantageous embodiment of the present invention provides that the fairground ride has at least one reader which is set up to communicate with the radio unit of the sensor system for increasing the safety of a fairground ride. The reader is positioned along a rail guide on a roller coaster, for example, so that the reader can detect the electrical resistance of the at least one measuring conductor or the electrical conductivity of the at least one measuring conductor by means of at least one sensor according to the invention when the vehicle drives past.

In addition, it is advantageous if the fairground ride has at least one camera-based monitoring system by means of which an optical detection of the medium is possible. The monitoring system can further preferably have a radiation source by means of which appropriate light waves are generated for the optical detection of the medium, which light waves excite the medium to fluoresce. The light source can preferably emit UV light.

Two exemplary embodiments of the present invention are described in detail below with reference to the accompanying drawings. In the drawings:

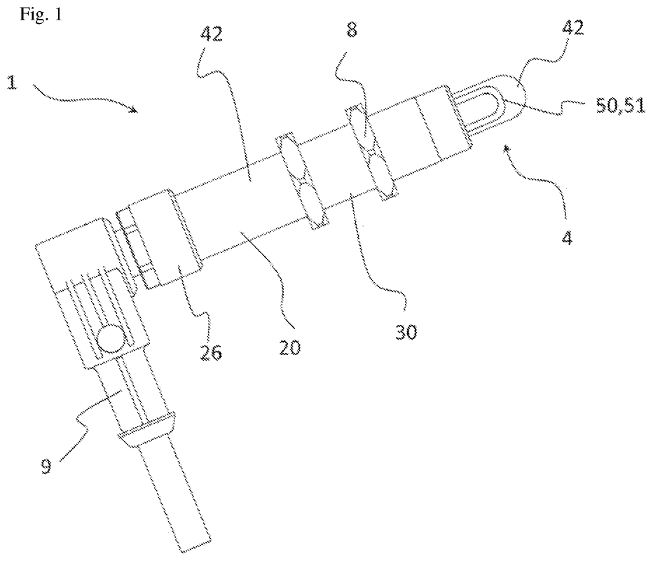

FIG. 1 shows a perspective illustration of a first exemplary embodiment of the sensor system according to the invention with a sensor housing and a sensor head which is inserted into a receiving region on the sensor housing and has a breaking body designed as a glass ampoule;

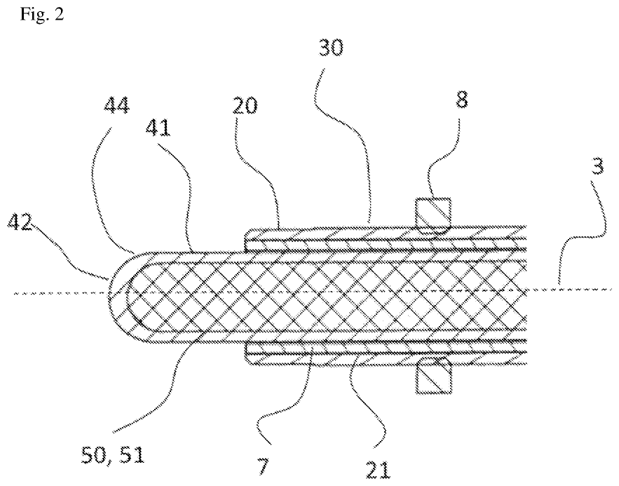

FIG. 2 shows a simplified sectional illustration of the sensor system according to FIG. 1;

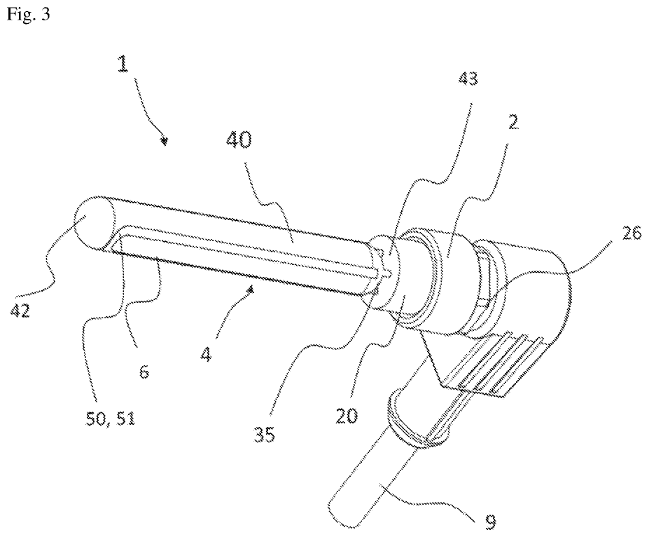

FIG. 3 shows a perspective illustration of a second exemplary embodiment of the sensor system according to the invention;

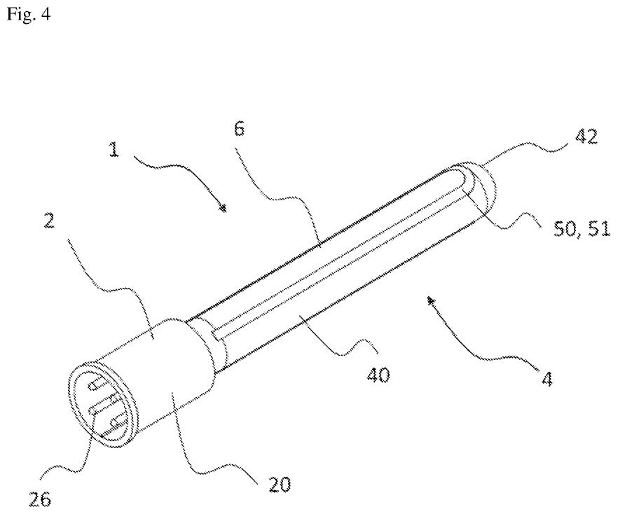

FIG. 4 shows a further perspective illustration of the exemplary embodiment according to FIG. 3;

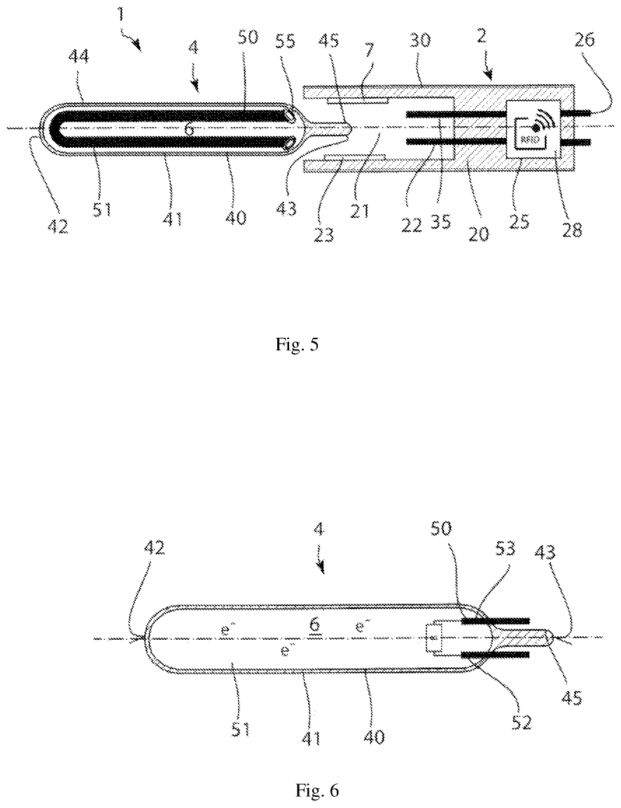

FIG. 5 shows a schematic and sectional representation of the sensor system according to FIG. 1; and

FIG. 6 shows a schematic and sectional illustration of a further development of the sensor head;

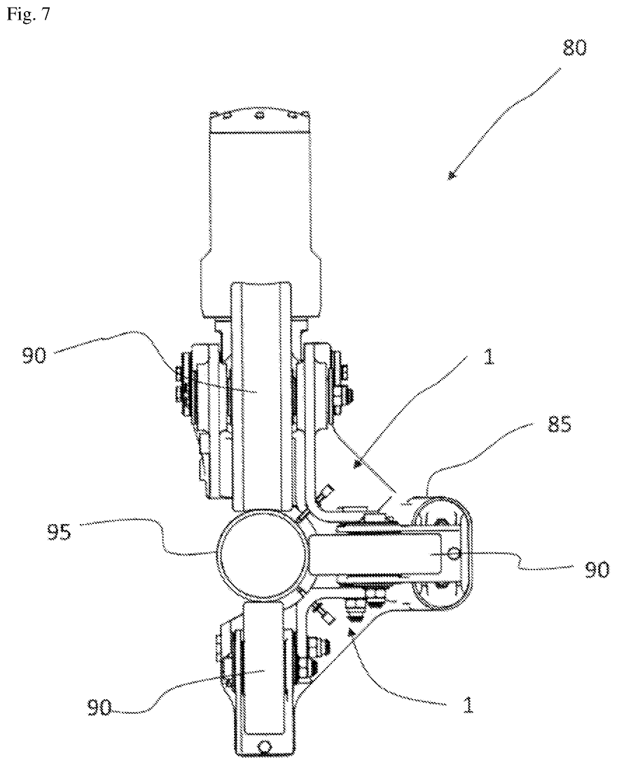

FIG. 7 shows a schematically illustrated installation situation of the sensor system according to the invention according to FIG. 1 on a rail-guided vehicle of a fairground ride; and

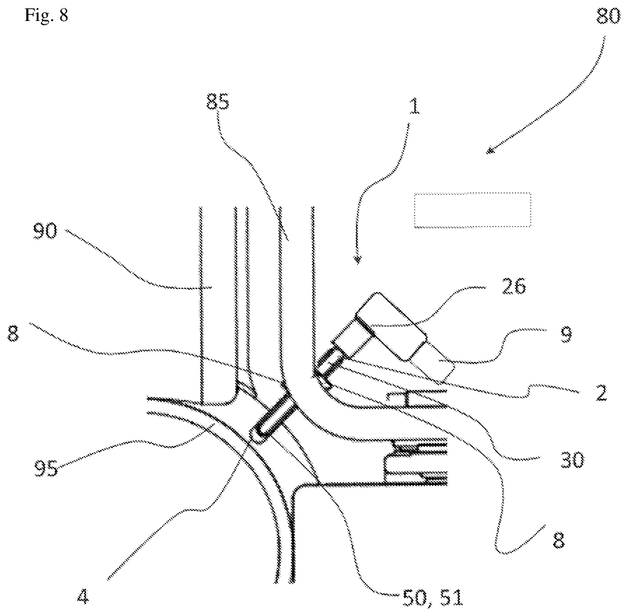

FIG. 8 shows a detailed illustration of the installation situation of the sensor system according to FIG. 7.

In the following, two preferred exemplary embodiments of a sensor system 1 according to the invention with a sensor head 4 and a further development of the sensor head 4 are described in detail with reference to FIG. 1 to FIG. 8, functionally identical parts being provided with the same reference numerals.

FIG. 1 shows a first exemplary embodiment according to the invention of the sensor system 1. The sensor system 1 comprises a sensor housing 2 and a sensor head 4, the sensor housing 2 being formed from a hollow cylindrical housing body 20 which has a receiving region 21 designed as a recess. As can be seen in particular from the sectional illustration in FIG. 2 or 5, the housing body 20 is formed coaxially to a longitudinal axis 3 and surrounds a receiving region 21 which is also aligned coaxially to the longitudinal axis 3.

The sensor housing 2 or the housing body 20 has a fastening means 30, which in the illustrated exemplary embodiment is designed as a fine thread M12x1, whereby the sensor housing 2 is fastened to the at least one component to be monitored, as shown for example in FIGS. 7 and 8.

The receiving region 21 is arranged on the side of a first end of the housing body 20, while a sensor cable connection 26 is provided on the side of a second end of the housing body 20. An electrical connection can be established, for example, to a monitoring circuit of a fairground ride by the sensor cable connection 26.

The sensor head 4 is arranged on the receiving region 21 on the sensor housing 2, or inserted into the receiving region 21 designed as a recess, and protrudes freely along the longitudinal axis 3 from the first end of the housing body 20.

The sensor head 4 comprises a breaking body 40 with at least one measuring conductor 50, wherein the breaking body 40 can be made from a glass material as an ampoule and can have a wall 41 which encloses a medium 6. Alternatively (not shown), the breaking body 40 can be designed as a solid body which receives the measuring conductor 50.

The medium 6 in the breaking body 40 can be any medium, for example a liquid with high fluidity. Furthermore, the medium can be mixed with a fluorescent agent.

In the exemplary embodiment shown, the breaking body 40 has two measuring conductors 50, which are each designed as electrically conductive U-shaped contact loops 51. The measuring conductors 50 or the contact loops 51 extend on the outside of the wall 41, that is to say the side facing away from the medium 6, between a breaking body foot 43 and a breaking body head 42. Furthermore, FIGS. 1 and 2 show that the contact loops 51 extend substantially over the entire length of the breaking body 40.

It is important here that the contact loop 51 always extends, at least in some areas, over the area which protrudes from the first end free of the receiving region 21 or sensor housing 2.

In the area of the breaking body foot 43, the breaking body 40 has two contact points 55, see FIG. 5, per contact loop 51, which are electrically connected to one another by the measuring conductor 50 or the contact loop 51. Each measuring conductor 50 accordingly has a contact point 55 at both ends.

Furthermore, FIG. 2 shows that the sensor head 4 has two contact loops 51, which are arranged diametrically around the longitudinal axis 3. In order to protect the contact loops 51, the breaking body 40 is provided with a coating 44 made, for example, of a brittle material, for example glass or ceramics. Alternatively, other electrically insulating materials can also be used for the coating 44, in particular plastic, lacquer or the like.

Between the sensor housing 2 and the sensor head 4, a guide 7 is provided in the receiving region 21, by means of which the sensor head 4 is held in a damping manner in the receiving region 21. In addition, by suitably dimensioning the guide 7, it can also be used as a clamping device 23 which locks the sensor head 4 in the receiving region 21. The guide 7 is preferably made of a rubber-elastic material, for example an elastomer, rubber or latex material, which has a hardness of approximately 70 Shore.

Each contact loop 51 is connected to an electronic measurement unit 25, see FIG. 5, by means of contact points 55 and electrical connections 35, the electronic measurement unit 25 connecting the sensor cable connection 26 to the at least one measuring conductor 50. The electronic measurement unit 25 can also have one or more electrical circuits or logic modules, by means of which one or more measuring conductors 50 are connected in parallel or in series. As FIG. 5 shows, the electronic measurement unit 25 can also have a radio unit 28.

The basic function of the electronic measurement unit 25 is to establish an electrical connection between the at least one measuring conductor 50 and the sensor cable connection 26, so that the sensor system 1 can determine the electrical conductivity or the electrical resistance of the measuring conductor 50 through a monitoring circuit of a fairground ride.

The electrical connection between the measuring conductor 50 and the electronic measurement unit 25 can be realized by a plug connection, which is made for example in FIG. 5 by the sensor housing 2 and in FIG. 6 by the sensor head 4.

The embodiment shown in FIG. 3 differs from the embodiment shown in FIGS. 1 and 2 in the design of the sensor housing 2, it being evident that the sensor housing 2 is a substantially cylindrical body, which can for example be glued, plugged in or fastened in some other way to the at least one component of the fairground ride to be monitored. The receiving region 21 is formed by an end face at the first end of the sensor housing 2, with four electrical connections 35 protruding from the sensor housing 2, each of which is designed to be connected to one end of a measuring conductor 50 or a contact loop 51.

The sensor head 4 is designed substantially analogously to the sensor heads 4 shown in FIGS. 1 and 2 and is a cylindrical container with a rounded breaking body head 42 and a rounded breaking body foot 43.

The shape of the breaking body 40 can be designed in any way, with rotationally symmetrical cross-sections in the longitudinal axis 3 being preferred for manufacturing reasons.

The side of the sensor system 1 facing away from the breaking body 40 can be seen in FIG. 4, it being evident that the sensor cable connection 26 has four electrical connections 35, each of the electrical connections 35 being connected to one end of one of the two contact loops 51.

The schematic representation of the sensor system in FIG. 5 shows that the sensor housing 2 can have a radio unit 28 by means of which the electrical resistance or the electrical conductivity of the measuring conductor 50 can be checked.

In the exemplary embodiment shown in FIG. 5, the radio unit 28 is an RFID chip that can be wirelessly controlled and read out by a reader. The RFID chip has an identification number or identifier by which it can be uniquely identified. The RFID chip is controlled and read out by the reader, as a result of which the RFID chip is stimulated by means of a UHF frequency and generates a current that is passed through the measuring conductor 50 of the sensor head 4. The result of the measurement of the electrical conductivity of the measuring conductor 50 is forwarded by the RFID chip 28 to the reader, which is in turn connected, for example, to a monitoring circuit of the fairground ride. Depending on the conductivity of the measuring conductor 50, a switching signal, an emergency stop or the like can be initiated by the monitoring circuit.

The breaking body 40 has an elongated breaking body tip 45 in the region of the breaking body foot 43, which tip is designed to produce a non-positive and/or positive coupling with the sensor housing 2. For this purpose, a spring cage can be formed in the receiving region 21 on the sensor housing 2, for example, which cage grips around the breaking body tip 45 and clamps it, which fastens the sensor head 4 in the receiving region 21 to the sensor housing 2.

FIG. 6 shows a schematic and sectional illustration of a further development of the sensor head 4. The sensor head 4 is made from an ampoule which is filled with an electrically conductive medium 6 and forms the breaking body 40. The at least one measuring conductor 50 of the sensor head 4 consists of a first electrode 52 and a second electrode 53, which are electrically connected by means of the electrically conductive medium 6. For this purpose, the first electrode 52 and the second electrode 53 protrude insulated from one another and spaced apart into the medium 6 within the wall 41 of the ampoule, so that an electric current can flow between the ends of the electrodes 52, 53 protruding freely into the medium. In the event of mechanical changes in the component to be monitored, even slight stresses can lead to cracks in the breaking body 40, through which the medium can flow out, whereby the electrical connection between the first electrode 52 and the second electrode 53 is interrupted. It can advantageously be provided that the medium 6 in the breaking body 40 is pressurized. As a result, the outflow of the medium 6 is facilitated even with the finest hairline cracks and mechanical changes in the at least one component to be monitored are detected at an early stage.

A combination of at least one measuring conductor 50, which is formed from a contact loop 51, with at least one measuring conductor 50, which is formed by a first electrode 52, a second electrode 53 and the electrically conductive medium 6, is provided according to the invention and can increase measurement reliability.

The use of the sensor system 1 for increasing the safety of a fairground ride can be seen on a fairground ride 80 in FIGS. 7 and 8.

FIGS. 7 and 8 show a section from a rail-guided fairground ride 80, namely a roller coaster, wherein, as can be seen in detail in FIG. 8, two sensor systems 1 are used to monitor the guidance of a rail-guided vehicle 85. The sensor systems 1 are each arranged between two adjacent guide wheels 90 on a side facing a guide rail 95 in such a way that the sensor heads 4 protrude freely out of the sensor housing 2 in the direction of the guide rail 95. The fastening of the sensor systems 1 to the rail-guided vehicle 85 takes place from the interaction of the fastening means 30 and two threaded nuts 8, which enables the sensor systems 1 to be precisely positioned on the rail-guided vehicle 85.

In the event of a mechanical change in the rail-guided vehicle 85, for example, the sensor heads 4 come into contact with the guide rail 95, as a result of which the breaking body 40 breaks or is destroyed. The medium 6 can run out of the breaking body 40 or the ampoule and leave a colored marking on the adjacent components. At the same time, if the wall 41 of the ampoule or the breaking body 40 is destroyed, the at least one measuring conductor 50 is severed so that the resistance of the measuring conductor 50 or the contact loop 51 approaches infinity or the measuring conductor 50 is no longer electrically conductive due to an interruption. While the interruption of the measuring conductor 50 can be detected by electronic means, the colored marking by the medium 6 can be automatically detected optically using a camera, for example by means of UV light, or visually by the operating personnel during a visual inspection.

Thus, according to the invention, a sensor system 1 for increasing the safety of the fairground ride is provided, as well as a fairground ride that can detect, in different ways and with multiple redundancy, mechanical changes in at least one component to be monitored. The sensor system 1 according to the invention can be operated both wired and wirelessly, and enables at least two different measurement techniques for detecting a mechanical change, in particular a mechanical change such as material fatigue and wear, in the at least one component to be monitored. On the one hand, an electrical signal is always generated and, on the other hand, a visually and/or optically perceptible coloring of the component affected by the mechanical change is achieved.

The sensor system according to the invention can also be operated without any electrical components, so that the mechanical changes, in particular material fatigue and wear, are read out when the breaking body breaks, for example due to fluorescent liquids. Reading out in the dark using appropriate readers, for example UV lamps, is also conceivable.

### LIST OF REFERENCE NUMERALS

1 Sensor system

2 Sensor housing

4 Sensor head

6 Medium

7 Guide

8 Threaded nut

9 Sensor cable

20 Housing body

21 Receiving region

22 Plug contact

23 Clamping device

25 Electronic measurement unit

26 Sensor cable connection

28 RFID chip

30 Fastening means

35 Electrical connection

40 Breaking body

41 Wall

42 Breaking body head

43 Breaking body foot

44 Coating

45 Breaking body tip

50 Measuring conductor

51 Contact loop

52 First electrode

53 Second electrode

55 Contact point

1. A sensor system (1) for the early detection of mechanical changes, in particular material fatigue and wear, comprising
a sensor housing (2) with a receiving region (21) and
a sensor head (4),
wherein the sensor head (4) is held on the receiving region (21) on the sensor housing (2) and protrudes at least in some areas from the sensor housing (2),
wherein the sensor head (4) comprises a breaking body (40) with at least one measuring conductor (50),
wherein the at least one measuring conductor (50) is electrically connected in the sensor housing (2) by means of at least one electronic measurement unit (25), and
wherein the electrical resistance of the at least one measuring conductor (50) can be detected by the electronic measurement unit (25).

2. The sensor system according to claim 1, characterized in that the breaking body (40) is made of an electrically insulating material, and that the at least one measuring conductor (50) is arranged as a contact loop (51) in or on the breaking body (40).

3. The sensor system (1) according to claim 1, characterized in that at least one electrical connection (35) between the measuring conductor (50) and the electronic measurement unit (25) is a plug connection.

4. The sensor system (1) according to claim 1, characterized in that the sensor head (4) is held positively and/or non-positively in the receiving region (21) on the sensor housing (2) by the electrical connection (35).

5. The sensor system (1) according to claim 1, characterized in that a guide (7) is provided in the receiving region (21) between the sensor housing (2) and the sensor head (4), and that the guide (7) is made of a damping material.

6. The sensor system (1) according to claim 1, characterized in that the breaking body (40) is made of a brittle material, preferably a ceramic material or glass.

7. The sensor system (1) according to claim 1, characterized in that the breaking body (40) is made of an elastic material, preferably rubber, in particular hard rubber.

8. The sensor system (1) according to claim 1, characterized in that the breaking body has an ampoule with a wall (41) which encloses a container with a medium (6).

9. The sensor system (1) according to claim 8, characterized in that the at least one measuring conductor (50) extends in or on the wall (41).

10. The sensor system (1) according to claim 8, characterized in that the medium (6) is electrically conductive, and that the at least one measuring conductor (50) is formed from a first electrode (52) and a second electrode (53), which in the breaking body (40) protrude into the medium (6) at a distance from one another.

11. The sensor system (1) according to claim 8. characterized in that the medium (6) comprises a liquid and/or a gas, and that the medium (6) is provided with a visually and/or optically and/or olfactorily perceptible marker.

12. The sensor system (1) according to claim 8, characterized in that the medium (6) comprises a pourable granular or lumpy mixture.

13. The sensor system (1) according to claim 8 characterized in that the medium in the sensor head (4) is pressurized.

14. The sensor system (1) according to claim 1, characterized in that the sensor head (4) has a substantially cylindrical shape, and that the sensor head (4) in the receiving region (21) is radially surrounded in some areas by the sensor housing (2).

15. The sensor system (1) according to claim 1, characterized in that the sensor housing (2) has at least one fastening means (30) which is set up to fasten the sensor housing (2) to at least one component to be monitored.

16. The sensor system (1) according to claim 15, characterized in that the at least one fastening means (30) has an external thread.

17. The sensor system (1) according to claim 1, characterized in
that the sensor housing (2) has a sensor cable connection (26) which is set up to be connected to a monitoring circuit of a fairground ride.

18. The sensor system (1) according to claim 1, characterized in that the electronic measurement unit (25) have a radio unit (28), by means of which the electrical resistance of the at least one measuring conductor (50) can be queried wirelessly.

19. The sensor system (1) according to claim 1, characterized in that the radio unit (28) is an RFID chip that can be controlled and read out.

20. The sensor head (4) of a sensor system according to claim 1, wherein the sensor head (4) comprises a breaking body (40) with at least one measuring conductor (50).

21. The sensor head (4) according to claim 20, characterized in that the breaking body (40) is made of an electrically insulating material, and that the at least one measuring conductor (50) is arranged as a contact loop (51) in or on the breaking body (40).

22. The sensor head (4) according to claim 20, characterized in that the breaking body (40) is made from a brittle material, preferably from a ceramic material or glass, or that the breaking body (40) is made from an elastic material, preferably rubber, in particular hard rubber.

23. The sensor head (4) according to claim 20, characterized in that the breaking body (40) has a wall (41) which encloses a medium (6).

24. The sensor head (4) according to claim 20, characterized in that the medium (6) is electrically conductive, and that the at least one measuring conductor (50) is formed from a first electrode (52) and a second electrode (53), which in the ampoule (40) protrude into the medium (6) at a distance from one another.

25. The sensor head (4) according to claim 23, characterized in that the medium (6) is a liquid, and that the medium (6) is provided with a visually and/or optically and/or olfactorily perceptible marker.

26. A fairground ride with a sensor system (1) according to claim 1.

27. The fairground ride according to claim 26, characterized in that at least one radio reader is provided to be set up to communicate with the radio unit (28) of the sensor system (1).

28. The fairground ride according to claim 26, characterized in that at least one camera is provided, which is set up to optically capture a medium (6) escaping from the breaking body (40).
